(19) United States
(12) Patent Application Publication
(10) Pub. No.: US 2011/0234368 A1
(43) Pub. Date: Sep. 29, 2011

(54) TEMPERATURE CONTROL DEVICE AND TEMPERATURE CONTROL METHOD

(75) Inventor: Yong-Zhao HUANG, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/769,681

(22) Filed: Apr. 29, 2010

(30) Foreign Application Priority Data
Mar. 24, 2010 (CN) 201010131516.1

(51) Int. Cl. G05B 23/02

(52) U.S. Cl. 340/3.44

(57) ABSTRACT

A temperature control device is used to control a temperature of an electronic component. The temperature control device includes a temperature sensing circuit, a controlled unit, a caution circuit, and a microcontroller. The microcontroller is used to sense the temperature of the electronic component, and determine whether the sensed temperature is higher than a predetermined high temperature stored in the microcontroller. If the sensed temperature is higher than a predetermined high temperature, the microcontroller controls the controlled unit to cool the electronic component and count the number of times the electronic component is cooled. The microcontroller determines whether the count of cooling the electronic component is equal to a predetermined cooling count. If the count of cooling the electronic component is equal to the predetermined cooling count, the microcontroller starts the caution circuit.

### BACKGROUND

1. Technical Field

The present disclosure relates to control devices and control methods, and particularly, to a temperature control device and a temperature control method.

2. Description of Related Art

Most electronic components must operate within a certain temperature range. When the temperature of an electronic component is lower or higher than their specified temperature range, the electronic component may malfunction. Therefore, effective temperature control is imperative for the proper functioning of many electronic components.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an exemplary embodiment of a temperature control device, the temperature control device including a storage unit.

FIG. 2 is a block diagram of the storage unit of FIG. 1.

FIG. 3 is a flowchart of an embodiment of a temperature control method.

### DETAILED DESCRIPTION

The disclosure is illustrated by way of example and not by way of limitation in the figures of the accompanying drawings in which like references indicate similar components. It should be noted that references to “an” or “one” embodiment in this disclosure are not necessarily to the same embodiment, and such references mean at least one.

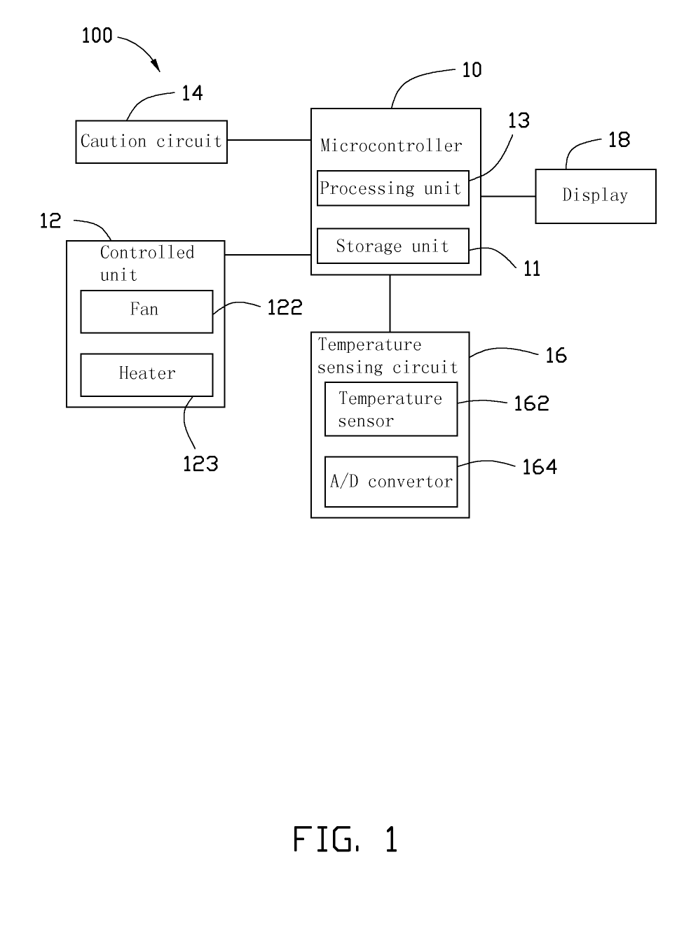

Referring to the FIG. 1, an exemplary embodiment of a temperature control device 100 is used to control a temperature of an electronic component (not shown). The temperature control device 100 includes a microcontroller 10, a controlled unit 12, a caution circuit 14, a temperature sensing circuit 16, and a display 18. The microcontroller 10 is connected to the controlled unit 12, the caution circuit 14, the temperature sensing circuit 16, and the display 18. The temperature sensing circuit 16 includes a temperature sensor 162 and an analog/digital (A/D) convertor 164. The controlled unit 12 includes a fan 122 and a heater 123.

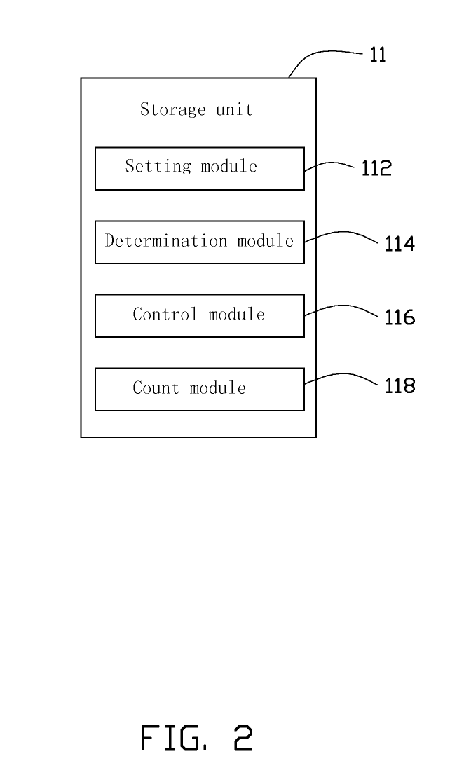

Referring to FIG. 2, the microcontroller 10 includes a storage unit 11 and a processing unit 13. The storage unit 11 includes a setting module 112, a determination module 114, a control module 116, and a count module 118. The setting module 112, the determination module 114, the control module 116, and the count module 118 may includes one or more computerized instructions which are executed by the processing unit 13.

The setting module 112 is used to receive a predetermined high temperature, a predetermined low temperature, a predetermined cooling count, a predetermined cooling time, and a predetermined heating time.

The control module 116 is used to control the temperature sensor 162 to sense a temperature of the electronic component, and output the analog temperature signal to the A/D convertor 164, and control the display 18 to display the sensed temperature of the electronic component. The A/D convertor 164 is used to convert the analog temperature signal into a digital signal and output the digital signal to the determination module 114.

The determination module 114 is used to determine whether the sensed temperature of the electronic component is higher than the predetermined high temperature. If the sensed temperature of the electronic component is higher than the predetermined high temperature, the determination module 114 outputs a cooling instruction to the control module 116. If the sensed temperature of the electronic component is lower than the predetermined low temperature, the determination module 114 outputs a heating instruction to the control module 116.

The control module 116 is also used to increase the speed of the fan 122 to try to cool the electronic component within the predetermined cooling time, and to repeat the cooling time if sensed temperature is still higher than the predetermined high temperature. The control module 116 is used to control the count module 118 to count the number of times the speed of the fan was increased. An initial value of the count module 118 is zero, that is, the count module 118 adds 1 each time the speed of the fan was increased. The control module 116 is further used to control the heater 123 to heat the electronic component within the predetermined heating time after receiving the heating instruction, and at the same time stop the fan 122 rotating.

The determination module 114 is further used to determine whether the count of increasing the speed of the fan 122 is equal to the predetermined cooling count. If the count of increasing the speed of the fan 122 is equal to the predetermined cooling count, the determination module 114 outputs a caution instruction to the control module 116 to caution an operator that the electronic component is cooled the predetermined cooling count continuously, which indicates the electronic component has failure. If the count of increasing the speed of the fan 122 is not equal to the predetermined cooling count, the determination module 114 continues determining whether the sensed temperature of the electronic component is higher than the predetermined high temperature.

The count module 118 can be cleared when the determination module 114 outputs the caution instruction, that is, the count of increasing the speed of the fan 122 is equal to the predetermined cooling count. The count module 118 also can be cleared when the electronic component is heated after the speed of the fan 122 is increased.

The control module 116 is further used to start the caution circuit 14 after receiving the caution instruction.

In other embodiments, the controlled unit 12 can be an air conditioner to replace the fan 122 and the heater 123. The heater 123 and the display 18 can be omitted.

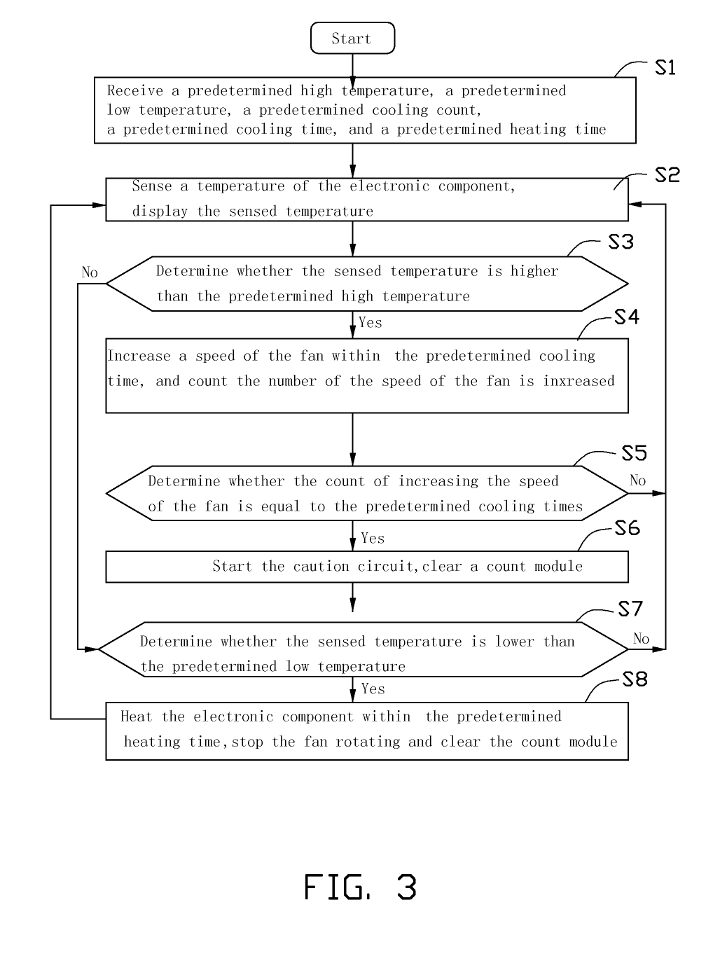

Referring to FIG. 3, an exemplary embodiment of a temperature control method is used to control the temperature of the electronic component. The temperature control method includes the following steps.

In step S1, the setting module 112 receives the predetermined high temperature, the predetermined low temperature, the predetermined cooling count, the predetermined cooling time, and the predetermined heating time.

In step S2, the control module 116 controls the temperature sensor 162 to sense the temperature of the electronic component. The temperature sensor 162 outputs the sensed temperature of the electronic component to the A/D convertor 164. The A/D convertor 164 converts the analog temperature signal into the digital signal and outputs the digital signal to the determination module 114. The control module 116 controls the display 18 to display the sensed temperature.

In step S3, the determination module 114 determines whether the sensed temperature of the electronic component is higher than the predetermined high temperature. If the sensed temperature of the electronic component is higher than the predetermined high temperature, the determination module 14 outputs the cooling instruction, and the procedure goes to the step S4. If the sensed temperature of the electronic component is lower than the predetermined high temperature, the procedure goes to the step S7.

In step S4, the control module 116 increase the speed of the fan 122 to cool the electronic component within the predetermined cooling time and increments the count of the number of times the speed of the fan has been increased.

In step S5, the determination module 114 determines whether the count of increasing the speed of the fan 122 is equal to the predetermined cooling count. If the count of increasing the speed of the fan 122 is equal to the predetermined cooling count, outputs the caution instruction, and the procedure goes to step S6. If the count of increasing the speed of the fan 122 is not equal to the predetermined cooling count, the procedure goes to step S2.

In step S6, the control module 116 starts the caution circuit 14 after receiving the caution instruction and clears the count module 118.

In step S7, the determination module 126 determines whether the sensed temperature of the electronic component is lower than the predetermined low temperature. If the sensed temperature of the electronic component is lower than the predetermined low temperature, outputs the heating instruction, the procedure goes to step S8. If the sensed temperature of the electronic component is higher than the predetermined low temperature, the procedure goes to step S2.

In step S8, the control module 116 controls the heater 123 to heat the electronic component within the predetermined heating time and stop the fan 122 rotating after receiving the heating instruction and clear the count module 118, the procedure goes to step S2.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A temperature control device to control a temperature of an electronic component, the temperature control device comprising:
a temperature sensing circuit to sense a temperature of the electronic component;
a controlled unit to cool the electronic component;
a caution circuit;
a microcontroller connected to the temperature sensing circuit, the controlled unit, and a caution circuit, the microcontroller comprising:
a processing unit; and
a storage system connected to the processing unit and storing a plurality of module to be executed by the processing unit, wherein the plurality of modules comprising:
a setting module to receive a predetermined high temperature and a predetermined cooling count;
a control module to control the temperature sensing circuit to sense a temperature of the electronic component and output the sensed temperature;
a determination module to determines whether the sensed temperature of the electronic component is higher than the predetermined high temperature, if the sensed temperature of the electronic component is higher than the predetermined high temperature, the determination module outputs a cooling instruction;
a count module to count the number of times the electronic component being cooled;
wherein the control module is further used to control the controlled unit to cool the electronic component after receiving the cooling instruction, and control the count module to count the number of times the electronic component is cooled, the determination module is also used to determine whether the count of cooling the electronic component is equal to the predetermined cooling count, if the count of cooling the electronic component is equal to the predetermined cooling count, the determination module outputs a caution instruction, the control module is further used to start the caution unit after receiving the caution instruction.

2. The temperature control device of claim 1, wherein the setting module is used to receive a predetermined cooling time, the control module controls the controlled unit to cool the electronic component within the predetermined cooling time.

3. The temperature control device of claim 2, wherein the setting module is used to receive a predetermined low temperature, if the sensed temperature of the electronic component is lower than the predetermined high temperature, the determination module is used to determine whether the sensed temperature of the electronic component is lower than the predetermined low temperature, if the sensed temperature of the electronic component is lower than the predetermined low temperature, output a heating instruction, the control module is used to control the controlled unit to heat the electronic component after receiving the heating instruction, and clear the count module.

4. The temperature control device of claim 3, wherein the controlled unit includes a fan, the control module is used to increase a speed of the fan after receiving the cooling instruction to cool the electronic component within the predetermined cooling time.

5. The temperature control device of claim 4, wherein the setting module is used to receives a predetermined heating time, the control module is used to control the controlled unit to heat the electronic component after receiving the heating instruction within the predetermined heating time.

6. The temperature control device of claim 5, wherein the controlled unit further comprises a heater, the control module controls the heater to heat the electronic component after receiving the heating instruction.

7. The temperature control device of claim 1, further comprising a display, wherein the control module is used to control the display to display the sensed temperature after the temperature sensing circuit sensed the temperature of the electronic component.

8. A temperature control method to control a temperature of an electronic component, the temperature control method comprising:
receiving a predetermined high temperature and a predetermined cooling count;
sensing the temperature of the electronic component, and outputting the sensed temperature;
determining whether the sensed temperature is higher than the predetermined high temperature, if the sensed temperature is higher than the predetermined high temperature, outputting a cooling instruction;
cooling the electronic component after receiving the cool instruction, and counting the number of times the electronic component being cooled;
determining whether the count of cooling the electronic component is equal to the predetermined cooling count, if the count of cooling the electronic component is equal to the predetermined cooling count, outputting a caution instruction; and
starting a caution circuit after receiving the caution instruction.

9. The temperature control method of claim 8, wherein the step “receiving a predetermined high temperature and a predetermined cooling count” further comprises receiving a predetermined cooling time; in the step “cooling the electronic component, and counting the number of times the electronic component being cooled”, the electronic component is cooled within the predetermined cooling time.

10. The temperature control method of claim 8, wherein in the step “cooling the electronic component, and counting the number of times the electronic component being cooled”, the electronic component is cooled via increasing a speed of a fan.

11. The temperature control method of claim 8, wherein the step “receiving a predetermined high temperature and a predetermined cooling count” further comprises receiving a predetermined low temperature, the temperature control method further comprising:
determining whether the sensed temperature of the electronic component is lower than the predetermined lower temperature if the sensed temperature of the electronic component is not higher than the predetermined high temperature, if the sensed temperature of the electronic component is lower than the predetermined lower temperature, output a heating instruction, and
heating the electronic component after receiving the heating instruction, and clearing the count of cooling the electronic component.

12. The temperature control method of claim 11, wherein the step “receiving a predetermined high temperature and a predetermined cooling count” further comprises receiving a predetermined heating time, in the step “heating the electronic component, and clearing the count of cooling the electronic component”, the electronic component is heated within the predetermined heating time.

13. The temperature control method of claim 12, wherein in the step “heating the electronic component, and clearing the count of cooling the electronic component”, the electronic component is heated via controlling a heater to heat the electronic component.
